(19) United States
(12) Patent Application Publication
(10) Pub. No.: US 2007/0130013 A1
(43) Pub. Date: Jun. 7, 2007

(54) Product card used as shopping list and marketing method

(76) Inventor: Lapalme Robert, Laval (CA)

Correspondence Address: INVENTARIUM, Suite 1607, 4050 Rosemont blvd, Montreal, QC, H1X 1M4, CA

(21) Appl. No.: 11/605,668

(22) Filed: Nov. 28, 2006

Related U.S. Application Data
(60) Provisional application No. 60/742,210, filed on Dec. 5, 2005.

(51) Int. Cl. G06Q 30/00

(52) U.S. Cl. 705/14

(57) ABSTRACT

A product card used as a shopping list tool features a written description and visual representation of a given product by way of a main image and a thumbnail image; a category/product classification; a card reference number used for advertising purpose to clearly identify the product card; a writing area for writing information; and a background color for the product card.

This application claims priority based on provisional application 60/742,210 filed Dec. 05, 2005

### FIELD OF THE INVENTION

The invention relates generally to reminder systems but more particularly to a system of cards displaying information used for setting up a shopping list.

### BACKGROUND OF THE INVENTION

Going shopping can be a somewhat daunting task fraught with frustrations for several shoppers as they always feel that they have forgotten something. In view of such frustrations, several shopping list reminder systems have been developed over the years. Some systems focus on the physical aspect of providing a container which holds cards, coupons or other such physical elements which provides the necessary information to clue the shopper in on what to buy, while others describe printed material combined with promotional items so as to create a method for creating and following a shopping list.

Prior Capability and Motivations, as Helping to Show Patentability Here

Even in hindsight consideration of the present invention to determine its inventive and novel nature, it is not only conceded but emphasized that the prior art had many details usable in this invention, but only if the prior art had had the guidance of the present invention, details of both capability and motivation.

That is, it is emphasized that the prior art had/or knew several particulars which individually and accumulatively show the non-obviousness of this combination invention. E.g.,
a) cost of paper, cardboard, print;
b) The nature of an invention as being a “novel combination”, in spite of existence of details separately, is especially significant here where the novelty is of the plurality of concepts, i.e., the use of cardboard cards diplaying visual content such as print and graphics to easily identify consumer products;
c) The addition of providing a small size or “thumbnail” image, a category/product classification icon, a card reference number used for advertizing purpose to clearly identify the product card, a writing area for writing information, and a background color for the product card;
d) The matter of particular cost-factors, in a detailed form which would surely convey the realization of the huge costs savings in creating such a simple shopping list system;
e) The prior art has always had more than ample skill to have achieved the present invention, but only if the concepts and their combinations had been conceived;
f) Substantially all of the operational characteristics and advantages of details of the present invention, when considered separately from one another and when considered separately from the present invention's details and accomplishment of the details, are within the skill of persons of various arts, but only when considered away from the integrated and novel combination of concepts which by their cooperative combination achieve this advantageous invention;
g) Similarly, and a long-recognized indication of inventiveness of a novel combination, is the realistic principle that a person of ordinary skill in the art, as illustrated with respect to the claimed combination as differing in the stated respects from the prior art both as to construction and concept, is presumed to be one who thinks along the line of conventional wisdom in the art and is not one who undertakes to innovate; and
h) The predictable benefits from a novel shopping list aid having the features of this invention would seem sufficiently high that others would have been working on this type of product, but only if the concepts which it presents had been conceived.

Accordingly, although the prior art has had capability and motivation, amply sufficient to presumably give incentive to the development a product and usage method according to the present invention, the fact remains that this invention awaited the creativity and inventive discovery of the present Inventor. In spite of ample motivation, the prior art did not suggest this invention.

Prior Art as Particular Instances of Failure to Provide this Novel Product and Installation Method

In view of the general advantages of the present invention as an improved embodiment of the prior art, it may be difficult to realize that the prior art has not conceived of the combination purpose and achievement of the present invention, even though in this increasingly busy world the need for an easy to use and easy to maintain and update shopping list creation tool is a known requested commodity for people nowadays who are distracted by many things and lose focus on what they need to do. With two people being responsible for shopping chances are that if both go about shopping without a precise list, they end up buying twice the same item or both forgetting the same important item. With such needs needing to be fulfilled and the technology to build such a tool being known for decades and that the various combination provided in this invention would have been desired and attempted long ago, but only if its factors and combination-nature had been obvious.

Other considerations, as herein mentioned, when realistically evaluated show the inventive nature of the present invention, a change in concept which the prior patent and other prior art did not achieve.

### SUMMARY OF THE PRIOR ART'S LACK OF SUGGESTIONS OF THE CONCEPTS OF THE INVENTION'S COMBINATION

And the existence of such prior art knowledge and related ideas embodying such various features is not only conceded, it is emphasized; for as to the novelty here of the combination, of the invention as considered as a whole, a contrast to the prior art helps also to remind of needed improvement, and the advantages and the inventive significance of the present concepts. Thus, as shown herein as a contrast to all the prior art, the inventive significance of the present concepts as a combination is emphasized, and the nature of the concepts and their results can perhaps be easier seen as an invention.

Although varieties of prior art are conceded, and ample motivation is shown, and full capability in the prior art is conceded, no prior art shows or suggests details of the overall combination of the present invention, as is the proper and accepted way of considering the inventiveness nature of the concepts.

That is, although the prior art may show an approach to the overall invention, it is determinatively significant that none of the prior art shows the novel and advantageous concepts in combination, which provides the merits of this invention, even though certain details are shown separately from this accomplishment as a combination.

And the prior art's lack of an invention of an economical, easy to use product card used as a shopping list achieving the practical advantages of the present invention, which are goals only approached by the prior art, must be recognized as being a long-felt need now fulfilled.

Accordingly, the various concepts and components are conceded and emphasized to have been widely known in the prior art as to various installations; nevertheless, the prior art not having had the particular combination of concepts and details as here presented and shown in novel combination different from the prior art and its suggestions, even only a fair amount of realistic humility, to avoid consideration of this invention improperly by hindsight, requires the concepts and achievements here to be realistically viewed as a novel combination, inventive in nature. And especially is this a realistic consideration when viewed from the position of a person of ordinary skill in this art at the time of this invention, and without trying to reconstruct this invention from the prior art without use of hindsight toward particulars not suggested by the prior art.

### FEATURES AND ADVANTAGES OF THE INVENTION

In view of the foregoing disadvantages inherent in the known devices now present in the prior art, the present invention, which will be described subsequently in greater detail, is to provide objects and advantages which are:

To provide for a shopping list that is easy to follow.

To provide for a shopping list that is easy to carry around.

To provide for a shopping list that is easy to customize and adapt.

To provide for a shopping list that offers new marketing possibilities to manufacturers of goods featured on the cards.

To attain these ends, the present invention generally comprises a product card used as a shopping list tool features a written description and visual representation of a given product. The product card further is comprised of;
a) a main image.
b) a thumbnail image.
c) a category/product classification icon.
d) a card reference number used for advertising purpose to clearly identify the product card.
e) a writing area for writing information.
f) a background color for the product card.
g) a product information such as logo, barcode, trademark, ingredients and nutrition facts.
h) Company information such as manufacturer name, logo, website address, postal address, and phone number.

The way to use the product card is as follows:

From a supply of the product cards, a user selects product cards representing products the user intends on purchasing so as to create the shopping list.

Optionally, the user can write information in the writing area. The user then goes on shopping based on the items shown on his selection of product cards. After purchases are made, the user puts the shopping list cards back in the supply of product cards.

Product manufacturers produce the product cards for distribution to end users by way of distribution means. Without limitations, and shown here as examples, the distribution means can be by way of product cards found on retail products.; by way of cards in flyers, and print media; or by way of manufacturers' websites from where a shopper can print product cards.

Product manufacturers produce the product cards for distribution to end users by way of distribution means. Without limitations, and shown here as examples, the distribution means can be by way of product cards found on retail products.; by way of cards in flyers, and print media; or by way of manufacturers' websites from where a shopper can print product cards.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiments of the invention.

### BRIEF DESCRIPTION OF THE DRAWINGS

FIG. 1 Perspective view of a deck of cards.

FIG. 2 Front view of a product card.

FIGS. 3-4 Front views of purchase separator and category separator respectively.

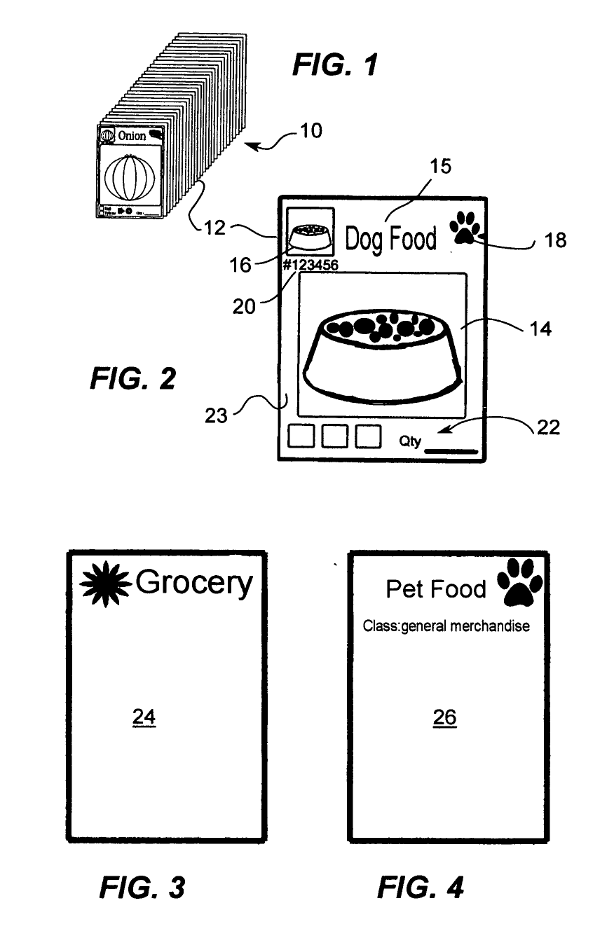

### DETAILED DESCRIPTION

A product card used as a shopping list (10) consists of at least one, but preferably a plurality of product cards (12). Each individual product card (12) identifies a single product by way of both written descriptions and visual representations. A typical product card (12) has the following elements:

A main image (14), to show the product and a written identification of the product (15), a thumbnail (16) image thematically related to the main image, a category or product classification icon (18). The thumbnail (16), by being in a corner of the product card (12), is made easily visible when flipping through product cards (12).

A card reference number (20) that can be used for advertizing purpose to clearly identify the product card (12). This is important since a product card (12) identifying, for example a box of cereal of brand X would have a reference number (20) different than that of a box of cereal of brand Y.

By having a specific reference number (20) which could in fact be the same as the bar code number (an image of which could be printed on the reverse of the product card (12)), the product card (12) can be used for special promotions. The manufacturer would be responsible for designing and even printing the product card (12) according to the specifications partly elaborated in this disclosure.

Elements such as product card (12) size will not be discussed here so as not to unduly restrict the scope of the invention but practical concerns dictate a reasonably compact size for the product cards (12) so that they can be easily carried and used for the purpose at hand. For example, in order to add more information such as product information such as logo, barcode, trademark, ingredients and nutrition facts; company information such as manufacturer name, logo, website address, postal address, and phone number, (not shown in the figures) there would be the need for more astute use of space or a larger format.

The two final elements consist in providing the product card (12) with a writing area (22) for writing, by the end user, such things as quantity, size, color and any information judged necessary for purchasing the proper product. Also, a background color (23) for the product card (12), provides a color coded way for easily identifying a product classification.

The product card (12) used as a shopping list (10), besides the product cards (12), has two types of separator cards, the first one being a place of purchase separator (24) which identifies a specific store or at the very least a type of store such as grocery store or department store, and behind which will be stacked the related product cards (12). The second type of separator card is the category separator (26) which subdivides products into categories or classification such as pet food, cleaning products, pharmaceuticals, etc.

An entire deck of product cards (12), that is the product cards (12), purchase separators (24), and category separators (26) can be located in a physical container which can take any of a variety of shapes. Also, when a shopping list is created from product cards (12) taken from the deck, the selected product cards (12) can be put into a specially designed wallet. The physical means for carrying and displaying the deck of product card (12) shopping list (10) can come in a variety of shapes and forms and will not be discussed here since it is mostly a question of design rather than of innovation.

The product card (12) can be obtained within or on the products being sold. The most evident example is inside a box of cereal or printed on the outside of a cardboard box. Since some products have labels that are too small or made of paper and other unsuitable physical support for the purpose of making a product card (12), these manufacturers could provide the product cards (12) in flyers, magazines or even on their websites from where a shopper can print product cards (12). Also, this invention could result in the creation of a service that manages and standardizes the application of this invention so that product manufacturers can, under licence, produce product cards (12) that would be distributed, through various means, to the public. Since the product cards (12) would be an ideal branding tool for a company, they would be interested in providing good graphics that includes their corporate logo and even changing the graphics from time to time so that product cards (12) could become collectibles.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention. Also, although the term (( product card )) is used throughout, it should be understood that consumers purchase products and services and it is quite conceivable that, for example, a dentist appointment card or consultation or any type of service could be provided on a shopping list of this kind.

1. A product card used as a shopping list tool comprising a written description and visual representation of a given product; said product card further comprised of;
a main image
a thumbnail image
a category/product classification icon.

2. A product card used as a shopping list tool as in claim 1 wherein: additional information is added which comprises
a card reference number used for advertizing purpose to clearly identify said product card
a writing area for writing information
a background color for said product card.

3. A product card as in claim 1 used as a shopping list having the following method of use:
a user selects from a supply of said product cards;
said product cards being selected to represent products said user intends on purchasing;
selected cards making up said user's shopping list;
said user writes in information in said writing area if required;
said user goes to shopping places to purchase items as described in said user's said shopping list;
after purchases are made, said user puts said shopping list cards in said supply of said product cards.

4. A marketing method using the product card of claim 1 wherein:
product manufacturers produce said product cards for distribution to end users by way of distribution means.

5. A marketing method as in claim 4 wherein:
said distribution means being by way of said product cards found on retail products.

6. A marketing method as in claim 4 wherein:
said distribution means being by way of said product cards in flyers, and print media.

7. A marketing method as in claim 4 wherein:
said distribution means being by way of manufacturers' websites from where a shopper can print said product cards.

8. A product card as in claim 2 used as a shopping list having the following method of use:
a user selects from a supply of said product cards;
said product cards being selected to represent products said user intends on purchasing;
selected cards making up said users shopping list;
said user writes in information in said writing area if required;
said user goes to shopping places to purchase items as described in said user's said shopping list;
after purchases are made, said user puts said shopping list cards in said supply of said product cards.

9. A marketing method using the product card of claim 2 wherein:
product manufacturers produce said product cards for distribution to end users by way of distribution means.

10. A marketing method as in claim 9 wherein:
said distribution means being by way of said product cards found on retail products.

11. A marketing method as in claim 9 wherein:
said distribution means being by way of said product cards in flyers, and print media.

12. A marketing method as in claim 9 wherein:
said distribution means being by way of manufacturers' websites from where a shopper can print said product cards.
